(19) United States
(12) Patent Application Publication
(10) Pub. No.: US 2020/0112489 A1
(43) Pub. Date: Apr. 9, 2020

(54) Intelligent Network Equipment Failure Prediction System

(71) Applicant: CenturyLink Intellectual Property LLC, Broomfield, CO (US)

(72) Inventors: Allan Scherger, Coon Valley, WI (US); Paul Johnson, Littleton, CO (US); Katie S. Feiman, Englewood, CO (US); Steven M. Casey, Littleton, CO (US)

(21) Appl. No.: 16/154,593

(22) Filed: Oct. 8, 2018

Related U.S. Application Data
(60) Provisional application No. 62/740,688, filed on Oct. 3, 2018.

(51) Int. Cl. H04L 12/24; G06N 99/00

(52) U.S. Cl. CPC H04L 41/147; H04L 41/0668; H04L 41/0631; H04L 41/0677; H04L 41/0806; G06F 11/008; H04L 41/12; H04L 41/5003; H04L 41/5022; G06N 99/005; H04L 41/16

(57) ABSTRACT

Novel tools and techniques for machine learning based quality of experience optimization are provided. A system includes one or more network elements, an orchestrator, and a server. The server may further include a processor and non-transitory computer readable media comprising instructions executable by the processor to obtain telemetry information from a first protocol layer, obtain telemetry information from a second protocol layer, modify one or more attributes of the second protocol layer, observe a state of first protocol layer performance, assign a cost associated with changes to each of the one or more attributes of the second protocol layer, and optimize the first protocol layer performance based, at least in part, on the state of first protocol layer performance and the cost associated with the changes to one or more attributes of the second protocol layer. The orchestrator may be configured to modify the one or more attributes of the second protocol layer.

### CROSS REFERENCE TO RELATED APPLICATIONS

This application claims priority to U.S. Provisional Patent Application Ser. No. 62/740,688, filed Oct. 3, 2018 by Allan Scherger et al. (attorney docket no. 1503-US-P1), entitled “Intelligent Network Equipment Failure Prediction System,” the entire disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to management systems for networks and network equipment, and more particularly to a machine learning system for predicting network equipment failure.

### BACKGROUND

As increasingly more services and applications grow to rely on networks and network resources, cloud platforms often offer network infrastructure-as-a-service. As network infrastructures continue to grow in both size and complexity, management of individual network elements within a network poses a challenge. Technology has emerged leveraging machine learning algorithms to predict and identify network failures, and to generate early-warning of predicted failures, and basic decision-making functionality for responding to the prediction and/or detection of network failures. However, current solutions are often limited in scope regarding the types of actions which may be taken by such machine-learning based failure prediction systems, as well as the types of systems with which the prediction systems may interface. For example, only a small subset of actions may be available for a small subset of network devices.

Accordingly, a more robust approach to intelligent network equipment failure prediction systems for handling network equipment failures are provided.

### BRIEF DESCRIPTION OF THE DRAWINGS

A further understanding of the nature and advantages of the embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic block diagram of an example architecture for an intelligent network equipment failure prediction system, in accordance with various embodiments;

FIG. 2 is a schematic block diagram of an intelligent network equipment failure prediction system, in accordance with various embodiments;

FIG. 3 is a flow diagram of a process performed by an intelligent network equipment failure prediction system, in accordance with various embodiments;

FIG. 4 is a schematic block diagram of a computer system for an intelligent network equipment failure prediction system, in accordance with various embodiments; and

FIG. 5 is a block diagram illustrating a networked system, which may be used in accordance with various embodiments.

### DETAILED DESCRIPTION OF CERTAIN EMBODIMENTS

The following detailed description illustrates a few exemplary embodiments in further detail to enable one of ordinary skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible, and/or non-transitory computer readable media (such as, to name but a few examples, optical media, magnetic media, and/or the like).

In an aspect, a system for intelligent network equipment failure prediction includes one or more network elements, a failure prediction system, and a learning management system. The failure prediction system may be coupled to the one or more network elements. The failure prediction system may be configured to receive a respective data stream of one or more key performance indicators for each of the one or more network elements respectively. The failure prediction system may further be configured to determine, based on at least one of the one or more key performance indicators, whether a network element of the one or more network elements is predicted to fail. The learning management system may be coupled to the failure prediction system. The learning management system may include a processor; and non-transitory computer readable media comprising instructions executable by the processor to perform various functions. Accordingly, the learning management system may be configured to receive a failure prediction indicating that the network element is predicted to fail an identifier of physical equipment comprising the network element from the failure prediction system. The set of instructions may then be executable by the processor to determine a location of the physical equipment comprising the network element, based on the identifier, and determine whether replacement equipment for the physical equipment is available. The learning management system may further be configured to provision the replacement equipment to perform one or more functions previously provided via the physical equipment.

In another aspect, an apparatus for intelligent network equipment failure prediction may include a processor and non-transitory computer readable media comprising instructions executable by the processor to perform various operations. In various embodiments, the instructions may be executable to receive, via a failure prediction system, a failure prediction indicating that the network element is predicted to fail, and an identifier of physical equipment comprising the network element. The instructions may further be executable to determine, via an inventory management system, a location of the physical equipment comprising the network element, based on the identifier, and whether replacement equipment for the physical equipment is available at the location of the physical equipment. The instructions may further be executable to provision, via a network management system, the replacement equipment to perform one or more functions previously provided via the physical equipment.

In a further aspect, a method for intelligent network equipment failure prediction includes receiving, via a failure prediction system, a failure prediction indicating that the network element is predicted to fail, and receiving, via the failure prediction system, an identifier of physical equipment comprising the network element. The method may continue by determining, via an inventory management system, a location of the physical equipment comprising the network element, based on the identifier, and determining, via the inventory management system, whether replacement equipment for the physical equipment is available at the location. The method may further include provisioning, via a network management system, the replacement equipment to perform one or more functions previously provided via the physical equipment.

Various modifications and additions can be made to the embodiments discussed without departing from the scope of the invention. For example, while the embodiments described above refer to specific features, the scope of this invention also includes embodiments having different combination of features and embodiments that do not include all the above described features.

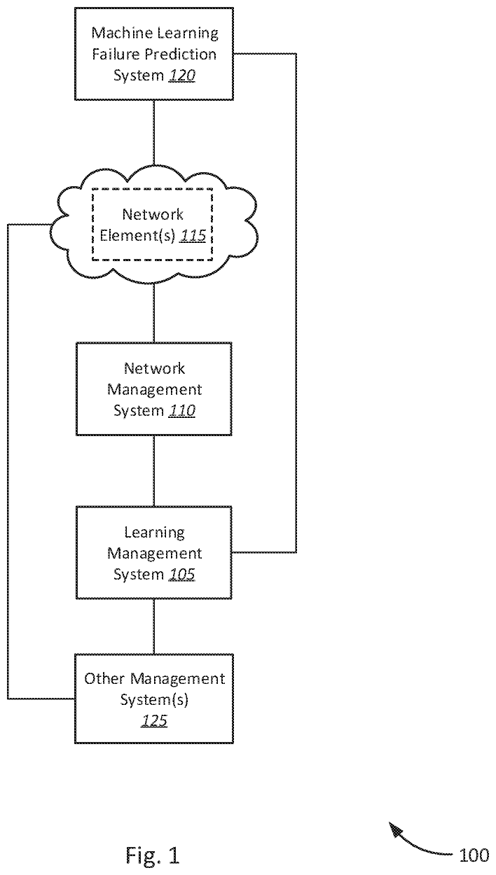

FIG. 1 is a schematic block diagram of an example architecture for an intelligent network equipment failure prediction system 100, in accordance with various embodiments. The system 100 includes a learning management system 105, network management system 110, one or more network elements 115, machine learning (ML) failure prediction system 120, and one or more other management systems 125. It should be noted that the various components of the system 100 are schematically illustrated in FIG. 1, and that modifications to the system 100 may be possible in accordance with various embodiments.

In various embodiments, the learning management system 105 may be coupled to the network management system 110, ML failure prediction system 120, and one or more other management systems 125. The network management system 110 may be coupled to the one or more network elements 115. The ML failure prediction system 120 may also be coupled to the one or more network elements 115. The network of one or more network elements 115 may include a plurality of network elements, through which telemetry information, key performance indicators (KPI), and other attributes may be obtained by the ML failure prediction system 120. The network management system 110 may be configured to monitor and make changes to the one or more network elements 115. The one or more other management systems 125 may be coupled to the learning management system 105, and the one or more network elements 115. The one or more other management systems 125 may provide the learning management system 105 with various inputs, and/or to allow the learning management system 105 to perform actions in response to inputs from the ML failure prediction system 120 and/or one or more other management systems 125.

In various embodiments, the learning management system 105 may include hardware, software, or hardware and software, both physical and/or virtualized. For example, in some embodiments, the learning management system 105 may refer to a software agent which may be deployed in either a centralized or distributed configuration. For example, in some embodiments, the learning management system 105 may be deployed on a centralized server, controller, or other computer system. In other embodiments, the learning management system 105 may be deployed in a distributed manner, across one or more different computer systems, such as servers, controllers, orchestrators, or other types of network elements. Accordingly, the learning management system 105 may be implemented on, without limitation, one or more desktop computer systems, server computers, dedicated custom hardware appliances, programmable logic controllers, single board computers, field programmable gate arrays (FPGA), application specific integrated circuits (ASIC), or a system on a chip (SoC).

In various embodiments, the learning management system 105 may be configured to obtain, from the ML failure prediction system 120, a determination that a network element of the one or more network elements 115 has failed or is predicted to fail. Accordingly, the ML failure prediction system 120 may be configured to determine when a network element of the one or more network elements 115 has failed or is predicted fail. In various embodiments, the ML failure prediction system 120 may be configured to obtain abstracted KPIs, and/or other telemetry information about each of the one or more network elements 115. The ML failure prediction system 120 may be configured to predict, based on the KPIs and/or other telemetry information, whether network equipment will fail. For example, in some embodiments, the one or more network elements 115 may be optical transport network equipment. Accordingly, suitable KPI and telemetry may include, without limitation, input optical power (IOP), laser bias current (LBC), laser temperature offset (LTO), output optical power (OOP), and environmental temperature (ET). In some embodiments, the ML algorithm used to determine a predicted failure may include, without limitation, a double-exponential smoothing (DES) and specific support vector machine (SVM), or a random forest, as known to those in the art. Thus, a DES-SVM approach may provide one example of an algorithmic approach for predicting network failures, while in other examples, a random forest approach may be used. It is to be appreciated that in other embodiments, the one or more network elements 115 may include other types of network equipment, which may in turn be associated with different types of KPIs and telemetry information related to and/or indicative of equipment failure. Moreover, it is to be understood that in different embodiments, different machine learning algorithms may be implemented to predict equipment failure.

For example, in other embodiments, threshold crossing alarms (TCA) may be implemented in combination with an ML algorithm, including different types of neural networks and/or deep learning approaches. In one example, a confusion matrix may be used to analyze the performance of a TCA. Conventional TCAs typically rely on a manually created rules-based approach to determining whether one or more thresholds have been exceeded, and to perform an action (e.g., alarm) in response to the threshold being exceeded. In one proposed approach, the rules for the TCA may be generated through an ML algorithm, which may be trained to identify various rules and thresholds indicative of equipment failure for a specific type of equipment. For example, the ML failure prediction system 120 may determine one or more KPI indicative of failure and/or predicted failure, as well as respective thresholds for the one or more KPI wherein exceeding the thresholds are indicative of failure and/or predicted failure. In yet further embodiments, ML based anomaly detection algorithms may be utilized to predict equipment failures. Equipment failure may include, without limitation, failure to deliver services that quantitatively meet QoS and/or SLA requirements (e.g., performance degradation), a mechanical failure of one or more parts within the physical equipment, and/or complete machine failure of the physical equipment.

Accordingly, in various embodiments, the learning management system 105 may be configured to receive, from the ML failure prediction system 120, an indication that one or more network elements 115 are failing or predicted to fail. The learning management system 105 may be configured to determine, for each predicted failure, an identification and/or identifier of specific physical equipment respectively associated with each of the one or more network elements predicted to fail, and a location respective location of each piece of identified equipment. For example, in some embodiments, at least one of the ML failure prediction system 120 or the network management system 110 may be configured to determine an identification (ID) of physical equipment associated with a network element predicted to fail. For example, in some embodiments, ID may be a unique identifier such as, without limitation, a network address, physical location (e.g., a street address, geographic coordinates, etc.), hardware ID or serial number, a media access controller (MAC) address, data center ID, or other data suitable for uniquely identifying the physical equipment, and a location of the identified physical equipment. In various embodiments, the network management system 110 and/or ML failure prediction system 120 may include respective APIs for the learning management system 105 to obtain information regarding the ID and location of a network element predicted to fail. In other embodiments, the network management system 110 and/or ML failure prediction system may be configured to provide the ID and location of any network element that has been predicted to fail, with or without the learning management system 105 making a separate API call.

The learning management system 105 may further be configured to determine a priority for repairing or replacing the identified physical equipment predicted to fail. For example, in some embodiments, the learning management system 105 may be configured to identify one or more affected parties (e.g., one or more customers, one or more third-party service providers), and/or one or more affected services (e.g., one or more services, one or more applications), associated with the one or more network elements predicted to fail. In some embodiments, the learning management system 105 may be configured to obtain this information via the one or more other management systems 125. Once the affected parties and services have been identified, the learning management system 105 may be configured to determine whether any service level agreements (SLA) or other quality of service (QoS) requirements are in place for those parties and/or services. For example, QoS requirements may refer to one or more quantitative measures of network performance, including, without limitation, service availability, bandwidth, network speed, latency, bitrate, packet loss, throughput, transmission delay, and jitter, among others. The learning management system 105 may, thus, determine a priority based on a third-party and/or a service associated with the network element predicted to fail. For example, if the ML failure prediction system 120 determines that two network elements of the one or more network elements 115 are predicted to fail, the learning management system 105 may determine that a first network element is associated with a first customer having a first SLA that prioritizes the service delivered to customers under the first SLA over customers under a different SLA. Thus, the learning management system 105 may determine that the replacement or repair of the first network element has a higher priority than the replacement or repair of the second network element. In this way, priorities may be determined for each network element of the one or more network elements 115 that are predicted to fail. In some embodiments, a numeric value may be assigned that is indicative of a priority level. Scores may, for example, vary based on the service level of respective SLAs. It is to be understood that in other embodiments, one or more different prioritizing and/or sorting algorithms may be utilized to determine a priority for a respective network element predicted to fail.

In further embodiments, the learning management system 105 may be configured to determine the availability of existing backup and/or replacement equipment. For example, the learning management system 105 may, based on information from the network management system 110 and/or other management systems 125, determine whether spares, backups, or replacement equipment is available, and the location of any identified spare, backup, and/or replacement equipment. In one example, the learning management system 105 may determine that two network elements have been predicted to fail. The learning management system 105 may further determine that backup equipment is available associated with the first network element, while replacement equipment for a second network element must be ordered.

Accordingly, in some embodiments, the learning management system 105 may cause the network management system 110 to transition away from the use of the first network element and migrate the services and/or customers handled by the first network element to the replacement equipment. In some embodiments, the network management system 110 may be configured to provision the replacement equipment for use, and to phase out the use of the first network element. For example, this may include provisioning the replacement equipment to handle network traffic previously handled by the first network element, to provide one or more services previously provided by the first network element, and/or to perform one or more functions previously performed by the first network element. For the second network element, may interface with various other management systems 125 to perform one or more actions for the repair or replacement of the second network element. For example, and without limitation, the learning management system 105 may be configured to identify suitable replacement equipment, order replacement equipment, and create work orders for replacing the identified second network element.

In some further embodiments, priority for repair or replacement may be determined based on the availability of spares, backups, and replacements. In some examples, network elements that may be immediately replaced with the use of an existing spare or backup may be prioritized to be addressed more quickly, for example, by the network management system 110. Network elements predicted to fail that are without available replacements, or with replacement parts that are located at a different location from the network element predicted to fail, may be prioritized based on the length of time anticipated before the network element may be replaced or repaired. Thus, network elements that will take longer to repair or replace may be prioritized to be addressed first by the learning management system 105. In one example, a numeric value representative of the length of time before replacement equipment may be obtained may be determined for each predicted failure, and priority determined according to the numeric value. In yet further embodiments, the learning management system 105 may be configured to determine priority based on a combination of the customer, existing SLAs, the availability of replacement equipment, among other factors. For example, in some further examples, an SLA may require spare equipment be available for a piece of network equipment that is not predicted to fail. Thus, in some embodiments, the learning management system 105 may be configured to determine spare equipment associated with the network equipment with the SLA is not to be used to replace a network element predicted to fail with a lower priority SLA.

In yet further embodiments, a physical equipment may host two or more different network elements. The physical equipment may be predicted to fail (e.g., fail to meet performance requirements) for only one of the two or more network elements. Accordingly, in some examples, replacement equipment may be provisioned for only the affected network element, while other network elements may remain on the physical equipment.

Accordingly, in various embodiments, different factors may be weighted or scaled more heavily than others. For example, in some embodiments, SLAs may be weighted more heavily than length of time required for repair. In yet further embodiments, between two network elements for which a single spare may be available, the spare may be used to replace a higher priority network element, and replacement equipment ordered for the lower priority network element. Accordingly, in some examples, network elements corresponding to customers with high priority SLAs may be given priority for repair relative to the other factors.

In further embodiments, other factors may be considered. For example, the ML failure prediction system 120 may further be configured to determine the immediacy of a failure. A first network element of the one or more elements 115 may be predicted to fail within 24 hours whereas a second network element may be predicted to fail within the next year. Accordingly, network elements predicted to fail within 24 hours may be prioritized for repair or replacement over network elements predicted to fail over longer timeframes. In further examples, additional factors considered for priority may include, without limitation, cost to repair or replace; regions, locations, or markets associated with a customer associated with the network element predicted to fail; regions, locations, or markets associated with the physical location of the network element itself; the number of customers and/or services associated with the network element predicted to fail; among various other factors which may be considered. Accordingly, various types of prioritizing algorithms, considering various factors, may be implemented at the learning management system 105 to determine a priority for the repair and/or replacement of network elements predicted to fail by the ML failure prediction system 120.

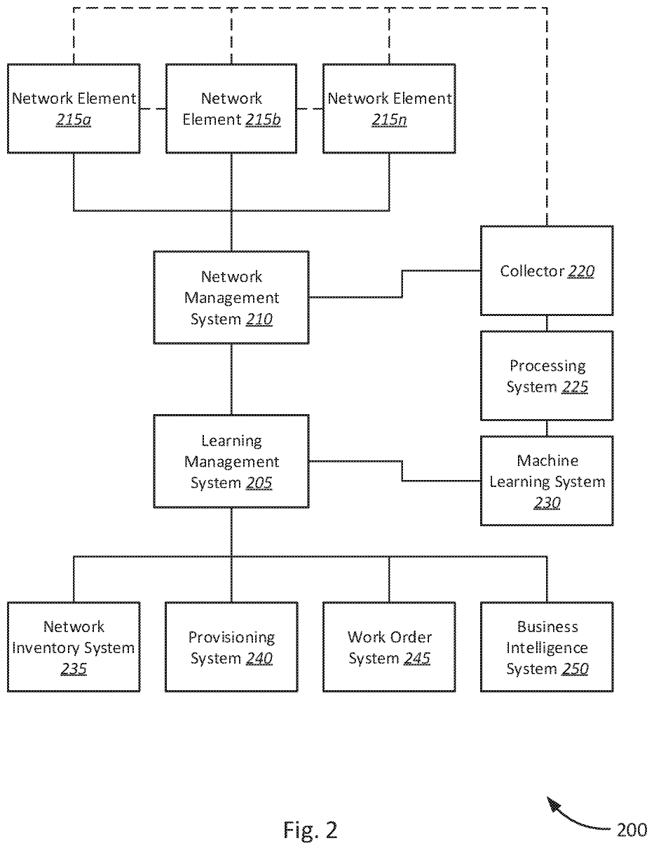

Once a priority has been determined for network elements predicted to fail, the learning management system 105 may further be configured to perform one or more actions to repair or replace network elements predicted to fail in order of priority and/or availability for repair and/or replacement. To perform the one or more actions, the learning management system 105 may be coupled to one or more other management systems 125 as previously described. The learning management system 105 may be configured to interface with each of the one or more other management systems 125 through one or more respective APIs, as will be discussed in greater detail with respect to FIG. 2. The one or more other management systems 125 may include, without limitation, various infrastructure control and management (ICM) systems, including various operations support systems (OSS), element management system (EMS), inventory management systems, service management systems, business intelligence systems, work order systems, and network management systems.

Once one or more actions have been taken by the learning management system 105, the learning management system 105 may be configured to update and/or adjust priorities assigned to each of the identified network elements based on a current state of the repairs and/or replacements for the respective network elements. Accordingly, in various embodiments, the one or more network elements 125 may be an abstracted representation of a service provider network, and specifically, network elements associated with a service provided to one or more customers. From the perspective of the learning management system 105, the relevant inputs (e.g., predicted failures, telemetry information, performance metrics, etc.) are provided via the ML failure prediction system 120 and/or network management system 110. Changes to the one or more network elements 115 may be made through the network management system 110 and/or one or more other management systems 125, without direct knowledge of the underlying network topology and individual network elements. Thus, the learning management system 105 may leverage existing systems to prioritize and perform repair and/or replacement of individual network elements predicted to fail by the ML failure prediction system 120.

Several of the techniques described above, can be implemented using the system 200 illustrated by FIG. 2. It should be noted, however, that this system 200 can operate differently in other embodiments (including without limitation those described herein) and using a system different from that depicted by FIG. 2. FIG. 2 is a schematic block diagram of an intelligent network equipment failure prediction system 200, in accordance with various embodiments. The system 200 includes a learning management system 205, network management system 210, first network element 215a, second network element 215b, nth network element 215n (collectively “network elements 215”), a collector 220, processing system 225, ML system 230, network inventory system 235, provisioning system 240, work order system 245, and business intelligence system 250. It should be noted that the various components of the system 200 are schematically illustrated in FIG. 2, and that modifications to the system 200 may be possible in accordance with various embodiments.

In various embodiments, the learning management system 205 may be coupled to the network management system 210, ML system 230, network inventory system 235, provisioning system 240, work order system 245, and business intelligence system 250. The network management system 210 may be coupled to each of the network elements 215. Accordingly, the learning management system 205 may be configured to interface or otherwise interact with the network elements 215 via the network management system 210. The network management system 210 may further be coupled to a collector 220, through which the collector 220 may be configured to obtain, for example, various KPIs, telemetry information, performance metrics, etc. Alternatively, the network elements 215 may be coupled to the collector 220, and configured to provide the collector 220 with, for example, various KPIs, telemetry information, performance metrics and the like. The collector 220 may be coupled to a processing system 225, which may in turn be coupled to the ML system 230.

As previously described, the learning management system 205 may be configured to obtain, from an ML failure prediction system, a determination that one or more of the network elements 215 is failing or is predicted to fail. In various embodiments, an ML failure prediction system may include the collector 220, processing system 225, and ML system 230. Accordingly, the collector 220 may be configured to monitor and collect various KPIs, performance metrics, or other telemetry information from the network elements 215. The collector 220 may include, without limitation, a centralized and/or distributed analytics environment for collecting respective data streams from the network elements 215.

In some embodiments, the collector 220 may include a dedicated hardware appliance. Alternatively, the collector 220 may be deployed as part of a centralized management system (or multiple management systems) associated with one or more data centers physically hosting the network elements 210, or in some examples, as part of the network management system 210, or an EMS. In some embodiments, the network management system 210 may further be coupled to and/or include one or more EMS, which are in turn coupled to one or more of the network elements 215.

In further embodiments, the collector 220 may include one or more “canaries,” that may be deployed across various data centers or in communication with each of the network elements 215a-215n. The canaries may be configured to act as proxies, configured to collect data streams of KPIs, telemetry information, and performance metrics from a subset of the network elements 215. Canaries may include various monitoring systems and/or instrumentation configured to collect data streams of KPIs and performance metrics associated with specific network elements 215 or subsets of network elements 215.

Accordingly, in various embodiments, the network management system 210 and/or collector 220 may be configured to actively poll and/or passively receive data from each of the network elements 215. For example, in some embodiments, data may be collected by polling of the network elements 215 by utilizing, for example, and without limitation, simple network management protocol (SNMP) based polling, network configuration protocol (NETCONF), RESTCONF/YANG protocols, transaction language 1 (TL1), and/or API calls to respective network elements 215a-215n or associated management systems, etc., or, alternatively, by passively receiving data (e.g., SNMP messages, alerts, and other data).

Data collected from the network elements 215 by the collector 220 may be provided to a processing system 225 for further pre-processing before delivery to the ML system 230. For example, in various embodiments, the processing system 225 may be configured to perform sorting, organizing, and other data processing of the data obtained by the collector 220. In some embodiments, the processing system 225 may be configured to obtain, from a data lake compiled by the collector 220, various KPIs considered by the ML system 230 to predict failures in individual network elements 215a-215n. For example, in various embodiments, the collector 220 may be configured to pool data into a data lake from the network elements 215. Each of the network elements 215 may correspond to different types of equipment from different vendors, and/or run different versions of firmware and/or software. Thus, data collected by the collector 220 in the data lake may include a large collection of heterogeneous data from diverse sources. In various embodiments, the processing system 225 may, accordingly, be configured to process data within the data lake into usable data by the ML system 230. For example, the processing system 225 may identify and obtain KPIs, such as, without limitation, IOP, LBC, LTO, OOP, and ET from the data lake collected by the collector 220. In other embodiments, other KPIs, telemetry information, and/or relevant performance metrics may be identified and processed into usable data by the ML system 230.

The ML system 230 may accordingly be configured to predict the failure of one or more of the network elements 215. As previously discussed, network elements 215 may include various types of physical equipment and/or VMs associated with physical equipment. Network elements may thus include, without limitation, optical transport network equipment, optical network terminals (ONT) and optical line terminations (OLT), optical cross connects (OXC), and other network devices such as NIDs, CPEs, routers, switches, servers, gateways, modems, access points, network bridges, hubs, repeaters, multiplexers (e.g., digital subscriber line access multiplexer (DSLAM), cable modem termination systems (CMTS), optical add-drop multiplexers (OADM)), and other types of network equipment.

Accordingly, depending on the type of network element 215, the ML system 230 may be configured to obtain the appropriate KPI for predicting failure. As previously discussed, in some embodiments, the network elements may include optical transport network equipment. KPI considered for optical transport network equipment may include IOP, LBC, LTO, OOP, and ET. In some embodiments, the ML system 230 may be configured to identify the KPI associated with or indicative of failure. For example, in some embodiments, one or more KPI may be identified by the ML system 230 via one or more ML techniques, such as clustering or reinforcement learning, as being related to or otherwise indicative of a predicted failure. In other embodiments, known KPI may be provided to the ML system 230 from which failure may be predicted.

The ML system 230 may, accordingly, utilize the various KPI to determine whether failure is predicted to occur. In some embodiments, the ML algorithm used to determine a predicted failure may include, without limitation, DES-SVM, or random forests, as known to those in the art. It is to be understood that in different embodiments, different machine learning algorithms may be implemented to predict equipment failure. For example, in other embodiments, threshold crossing alarms (TCA) may be implemented in combination with an ML algorithm, including different types of neural networks and/or deep learning approaches. In one example, a confusion matrix may be used to analyze the performance of a TCA. Conventional TCAs typically rely on a manually created rules-based approach to determining whether one or more thresholds have been exceeded, and to perform an action (e.g., alarm) in response to the threshold being exceeded. In one proposed approach, the rules for the TCA may be generated through an ML algorithm, which may be trained to identify various rules and thresholds indicative of equipment failure for a specific type of equipment. In yet further embodiments, ML based anomaly detection algorithms may be utilized to predict equipment failures. In some examples, anomalous KPI values or combinations of KPI values may be used to identify clusters and model vectors (e.g., combinations of clusters) indicative of a failure (or predicted failure).

In various embodiments, the ML system 230 may thus be configured to provide determinations of predicted failures to the learning management system 205. The learning management system 205 may be configured to interface with various management systems to perform various actions to repair or replace network elements 215a-215n predicted to fail. For example, the system 200 includes a network inventory system 235, provisioning system 240, work order system 245, and a business intelligence system 250. The network inventory system 235 may be a centralized system, such as, without limitation, a network inventory management system, configured to store and maintain information about network inventory. Thus, in various embodiments, the network inventory system 235 may include a database for storing information about network inventory. Accordingly, when new equipment is added to network inventory or existing equipment is removed from network inventory, the network inventory system 235 may be configured to update a database or index of network inventory entries. The network inventory system 235, for example, may store information regarding each piece of network equipment, including IDs and locations of equipment, as well as information regarding spare equipment including IDs and locations of spare equipment. The provisioning system 240 may be configured to automatically provision new equipment. For example, when equipment is added to the network, removed from the network, or replaced by a spare, the provisioning system 240 may be configured to automatically provision network equipment to be used. Automatically provisioning network equipment for use in the network may include interfacing with the network management system 210 to move various network functions and/or services provided by an old piece of equipment to the new equipment (in the case of replacements), or to begin utilizing new equipment for new functions and/or services. The work order system 245 may be configured to allow the learning management system 205 to place orders for new equipment and/or create work orders for the installation and provisioning of new equipment (including replacement of spares). The work order system 245 may further be configured to allow the learning management system 205 to create work orders for technicians or contractors to repair and/or replace equipment predicted to fail. Business intelligence system 250 may be configured to provide business metrics around traffic generated by one or more network elements 215a-215n. Business intelligence system 250 may further be configured to store and maintain information about customers associated with specific network elements 215 and/or physical equipment. Customer data may include any contracts, such as SLAs, and other technical requirements related to services provided to a customer (such as QoS requirements), resource availability, time and geographic restrictions and/or requirements, equipment backup or replacement (e.g., redundancy) requirements, requirements on storage and/or compute resources, network resource requirements, etc. Accordingly, in various embodiments, the learning management system 205 may be configured to interface with the various management systems 210, 235-250, via respective APIs, through which information may be obtained by and/or transmitted to the learning management system 205.

Accordingly, in various embodiments, the learning management system 205 may be configured to identify one or more of the network elements predicted to fail and determine a location (including physical location and/or a logical location) of the network element 215a-215n. As previously described, the learning management system 205 may be configured to determine, for each predicted failure, an ID associated with the specific physical equipment respectively associated with the network elements 215 predicted to fail. In some embodiments, the ML system 230 may be configured to determine and provide an ID of the physical equipment along with a determination that the physical equipment is predicted to fail. In other embodiments, the learning management system 205 may be configured to obtain an ID associated with the network element predicted to fail via a network management system 110. In various embodiments, the learning management system 205 may determine a location of the equipment identified based on the ID. An ID may include, without limitation, a network address, hardware ID or serial number, a media access controller (MAC) address, data center ID, or other data suitable for uniquely identifying the physical equipment. In further embodiments, the learning management system 205 may be configured to determine the ID of the network element 215a-215n predicted to fail via other management systems, such as the network inventory system 235.

In various embodiments, the learning management system 205 may further be configured to determine a location of a piece of physical equipment based on the ID, by looking up the ID in another management system. For example, in some embodiments, the learning management system 205 may be coupled to a network inventory system 235. The network inventory system 235 may be configured to store information about each piece of equipment in network inventory, including ID and location information. Accordingly, in some embodiments, the learning management system 205 may be configured to obtain location information from the network inventory system 235, based on the ID. Location information may include, without limitation, physical location (e.g., a street address, geographic coordinates, etc.), a data center ID (or location of a data center) where the physical equipment is located, or other information indicative of the location of the identified physical equipment.

The learning management system 205 may further be configured to determine a priority for repairing or replacing the identified physical equipment predicted to fail. For example, in some embodiments, the learning management system 205 may be configured to identify one or more affected parties (e.g., one or more customers, one or more third-party service providers), and/or one or more affected services (e.g., one or more services, one or more applications), associated with a network element 215a-215n predicted to fail. In some embodiments, the learning management system 205 may be configured to obtain customer information via the business intelligence system 250. Once the affected parties (e.g., customers) and services have been identified, the learning management system 205 may further be configured to determine whether any service SLAs or QoS requirements are in place for those parties and/or services, via the business intelligence system 250. The learning management system 205 may, thus, determine a priority based on the party and/or a service associated with the network element predicted to fail.

As previously described, if a first network element 215a is predicted to fail, the learning management system 205 may be configured to determine that the first network element 215a is associated with a first customer having a first SLA that prioritizes the service delivered to customers under the first SLA over customers under a different SLA. Thus, the learning management system 205 may determine that the replacement or repair of the first network element 215a has a higher priority than the replacement or repair of any other network element 215b-215n. In this way, priorities may be determined for each network element 215a-215n that are predicted to fail. In some embodiments, a numeric value may be assigned that is indicative of a priority level. A numeric value may, for example, be assigned based on the service level of respective SLAs. It is to be understood that in other embodiments, one or more different prioritizing and/or sorting algorithms may be utilized to determine a priority for a respective network element predicted to fail.

In further embodiments, other factors may be considered to determine priority. For example, the ML system 230 may further be configured to determine the immediacy of a failure. The learning management system 205 may, in turn, be configured to perform actions to address the more imminent failure first. For example, the first network element 215a may be predicted to fail within 24 hours whereas the second network element 215b may be predicted to fail within the next year. Accordingly, network elements 215a-215n predicted to fail within 24 hours may be prioritized for repair or replacement over network elements 215a-215n predicted to fail over longer timeframes. In further examples, additional factors considered for priority may include, without limitation, cost to repair or replace; regions, locations, or markets associated with a customer associated with the network element predicted to fail; regions, locations, or markets associated with the physical location of the network element itself; the number of customers and/or services associated with the network element predicted to fail; among various other factors which may be considered. Accordingly, various types of prioritizing algorithms, considering various factors, may be implemented at the learning management system 205 to determine a priority for the repair and/or replacement of network elements.

Once a priority has been determined for network elements predicted to fail, the learning management system 205 may further be configured to perform one or more actions to repair or replace network elements predicted to fail in order of priority and/or availability for repair and/or replacement. To perform the one or more actions, the learning management system 205

In various embodiments, the learning management system 205 may be configured to determine the availability of existing backup and/or replacement equipment. For example, the learning management system 205 may be configured to determine the availability of existing backup and/or replacement equipment based on information obtained from the network management system 210 and/or network inventory system 235. For example, when a network element 215a-215n and/or physical equipment associated with the network element 215a-215n has been identified by the learning management system 205, the learning management system 205 may be configured to further determine whether spares, backups, or replacement equipment are available, and the location of any identified spare, backup, and/or replacement equipment through respective API calls to the network inventory system 235 and/or the network management system 210.

In one example, the learning management system 205 may determine that two network elements have been predicted to fail. The learning management system 205 may further determine that backup equipment is available at the location associated with the first network element 215a, while replacement equipment for the second network element 215b must be ordered. Accordingly, in some embodiments, the learning management system 205 may be configured to cause the network management system 210 and/or provisioning system 240 to provision the replacement equipment for use, and to phase out the use of the first network element 215a. In some embodiments, the learning management system 205 may further cause the network management system 210 to transition services and/or customers from the first network element 215a to being handled by the replacement equipment. Accordingly, various applications, services, and resources previously provided by the first network element 215a may then be provided by the replacement equipment (e.g., moved, copied, or otherwise performed by the replacement equipment).

For the second network element 215b, in some embodiments, the learning management system 205 may interface with the work order system 245 to perform various actions for the repair or replacement of the second network element 215b. For example, and without limitation, the learning management system 205 may be configured to identify suitable replacement equipment, order replacement equipment, and create work orders for replacing the identified second network element 215b via the work order system 245. The learning management system 205 may then create entries or otherwise update network inventory via the network inventory system 235 to reflect the addition of the new replacement equipment.

In some further embodiments, priority for repair or replacement may further be determined based, at least in part, on the availability of spares, backups, and replacements. In some examples, network elements 215 that may be immediately replaced with the use of an existing spare or backup may be prioritized to be addressed more quickly. Network elements 215 predicted to fail that are without available replacements, or with replacements that are located at a different location from the network element 215a-215n predicted to fail, may be prioritized based on the length of time anticipated before the network element may be replaced or repaired. Thus, network elements 215 that will take longer to repair or replace may be prioritized to be addressed first by the learning management system 205. In one example, a numeric value representative of the length of time before replacement equipment may be obtained may be determined for each predicted failure, and priority determined according to the numeric value. In yet further embodiments, the learning management system 205 may be configured to determine priority based on a combination of the customer, existing SLAs, the availability of replacement equipment, among other factors. In various embodiments, different factors may be weighted or scaled more heavily than others. For example, in some embodiments, SLAs may be weighted more heavily than length of time required for repair. In yet further embodiments, between two network elements for which a single spare may be available, the spare may be used to replace a higher priority network element, and replacement equipment ordered for the lower priority network element. Accordingly, in some examples, network elements corresponding to customers with high priority SLAs may be given priority for repair relative to the other factors.

In yet further embodiments, once the learning management system 205 has taken performed one or more actions to address a predicted failure, the learning management system 205 may then be configured to update and/or adjust priorities assigned to each of the identified network elements based on a current state of the repairs and/or replacements for the respective network elements, and to handle the next predicted failure, in order of priority, as described above.

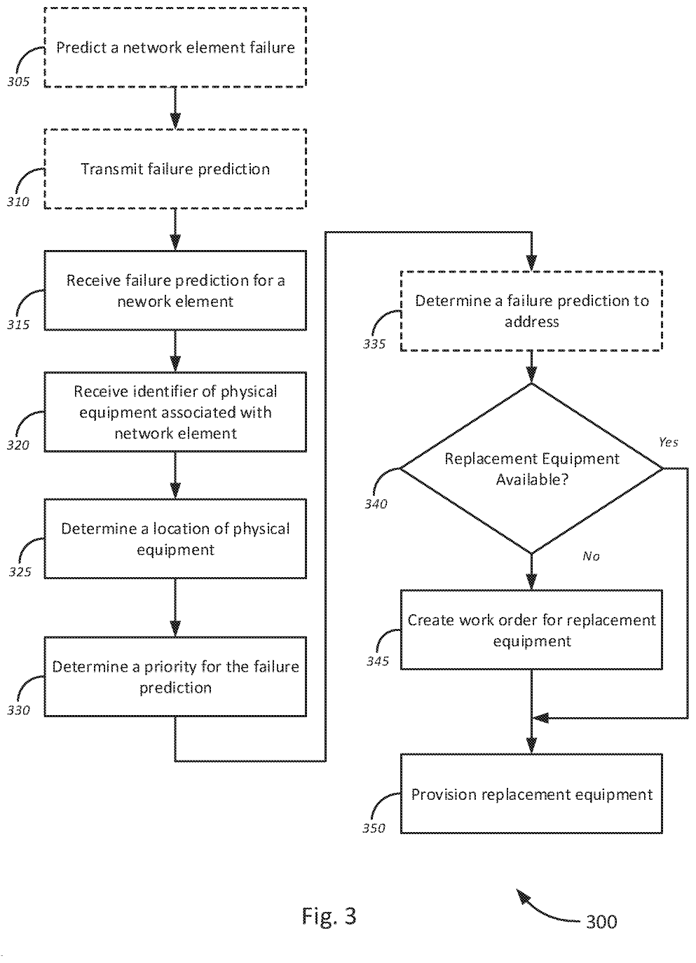

FIG. 3 is a flow diagram of a method 300 performed by an intelligent network equipment failure prediction system, in accordance with various embodiments. The method 300 begins, at optional block 305, by predicting a network elements failure. As previously described, an ML failure prediction system may be configured to predict whether one or more network elements are failing or will fail. Predicting when one or more network elements are failing or will fail may include determining a likelihood that one or more network elements will fail. In some examples, the failure may be predicted to occur within a threshold time period. In various embodiments, a network element may be predicted to fail based on respective data streams of one or more KPIs, as previously discussed. Values of the one or more KPIs exceeding a threshold may be determined, by the ML failure prediction system, to be indicative of a likelihood that failure will occur. In some embodiments, this may further include a time period within which the network element is likely to fail. In some embodiments, the ML failure prediction system may include a collector, processing system, and ML system as described above with respect to FIG. 2. The collector, network management system, and/or EMS may be configured to obtain data streams of various KPI, telemetry information, and/or other performance metrics. The processing system may be configured to obtain relevant KPI to be used by the ML system. The ML system may include a machine learning system configured to generate a failure prediction for a network element based on the various KPI. At optional block 310, the ML prediction system may be configured to transmit the failure prediction to a learning management system.

The method 300 continues, at block 315, by receiving the failure prediction at the learning management system. In various embodiments, the failure prediction may indicate that a given network element is predicted to fail. The learning management system, at block 320, may further receive an identifier for physical equipment associated with the network element. In various embodiments, a network element may refer to both physical and virtual devices. For example, an identifier may serve to identify the physical equipment comprising the network element (e.g., a physical host machine for a virtual network element).

At block 325, the method 300 continues by determining a location of the physical equipment associated with the network element predicted to fail. In some embodiments, the learning management system may be configured to interface with an inventory management system to determine, based on the identifier, a location of the physical equipment. A location may include a determination of physical location and/or logical location of the physical equipment, or a data center in which the physical equipment is located.

At block 330, the method 300 may continue by determining a priority for the failure prediction. In some embodiments, as previously described, the learning management system may be configured to determine, via a business intelligence system, the identity of a customer, an SLA, QoS requirements, or other information regarding the users and services associated with the network element predicted to fail. Accordingly, various factors from the business intelligence system may be used to determine a priority for the failure prediction. In further embodiments, the learning management system may further determine priority based on, without limitation, resource availability, time and geographic restrictions and/or requirements, equipment backup or replacement (e.g., redundancy) requirements and availability, estimated time for replacement or repair, requirements on storage and/or compute resources, network resource requirements, and other factors. Thus, in various embodiments, at optional block 335, the method 300 may further include determining a failure prediction to address in the order of priority. Higher priority failure predictions may be addressed before a lower priority failure prediction is addressed by the learning management system. For example, as previously described, the learning management system may cause a network element associated with a customer having a higher priority SLA to be replaced with replacement equipment before a different network element associated with a customer having a lower priority SLA.

At decision block 340, the learning management system may determine whether replacement equipment is available for the physical equipment associated with the network element predicted to fail. In response to determining that replacement equipment is not available, the learning management system may, at block 345, be configured to create a work order for replacement equipment, via a work order system. Accordingly, in some embodiments, the work order may be an order for new equipment (e.g., replacement equipment) to replace the physical equipment predicted to fail. The work order, in further embodiments, may include work orders for a technician to deliver or install new equipment, and/or repair existing equipment. The method may then continue, at block 350, by provisioning the replacement equipment for use within the network in place of the physical equipment predicted to fail. Similarly, if replacement equipment is determined to already be available, at block 350, the existing replacement equipment may be provisioned for use in place of the physical equipment predicted to fail.

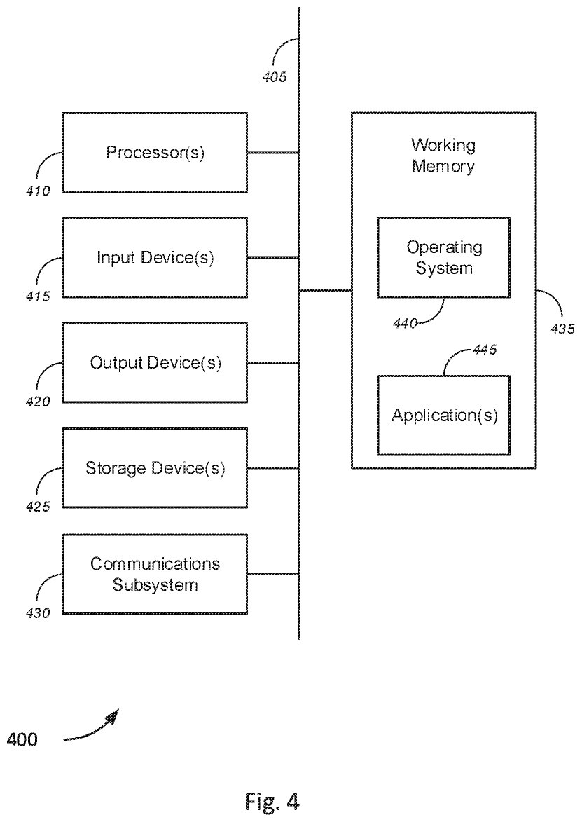

FIG. 4 is a schematic block diagram of a computer system 400 for an intelligent network equipment failure prediction system, in accordance with various embodiments. FIG. 4 provides a schematic illustration of one embodiment of a computer system 400, such as the learning management system, processing system, ML failure prediction system, collector, processing system, ML system, network management system, network inventory system, provisioning system, work order system, business intelligence system, ICM systems, and one or more network elements, which may perform the methods provided by various other embodiments, as described herein. It should be noted that FIG. 4 only provides a generalized illustration of various components, of which one or more of each may be utilized as appropriate. FIG. 4, therefore, broadly illustrates how individual system elements may be implemented in a relatively separated or relatively more integrated manner.

The computer system 400 includes multiple hardware elements that may be electrically coupled via a bus 405 (or may otherwise be in communication, as appropriate). The hardware elements may include one or more processors 410, including, without limitation, one or more general-purpose processors and/or one or more special-purpose processors (such as microprocessors, digital signal processing chips, graphics acceleration processors, and microcontrollers); one or more input devices 415, which include, without limitation, a mouse, a keyboard, one or more sensors, and/or the like; and one or more output devices 420, which can include, without limitation, a display device, and/or the like.

The computer system 400 may further include (and/or be in communication with) one or more storage devices 425, which can comprise, without limitation, local and/or network accessible storage, and/or can include, without limitation, a disk drive, a drive array, an optical storage device, solid-state storage device such as a random-access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer system 400 might also include a communications subsystem 430, which may include, without limitation, a modem, a network card (wireless or wired), an IR communication device, a wireless communication device and/or chip set (such as a Bluetooth™ device, an 802.11 device, a WiFi device, a WiMax device, a WWAN device, a Z-Wave device, a ZigBee device, cellular communication facilities, etc.), and/or a LP wireless device as previously described. The communications subsystem 430 may permit data to be exchanged with a network (such as the network described below, to name one example), with other computer or hardware systems, between data centers or different cloud platforms, and/or with any other devices described herein. In many embodiments, the computer system 400 further comprises a working memory 435, which can include a RAM or ROM device, as described above.

The computer system 400 also may comprise software elements, shown as being currently located within the working memory 435, including an operating system 440, device drivers, executable libraries, and/or other code, such as one or more application programs 445, which may comprise computer programs provided by various embodiments (including, without limitation, various applications running on the various server, LP wireless device, control units, and various secure devices as described above), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 425 described above. In some cases, the storage medium might be incorporated within a computer system, such as the system 400. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, single board computers, FPGAs, ASICs, and SoCs) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer system 400) to perform methods in accordance with various embodiments of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another computer readable medium, such as one or more of the storage device(s) 425. Merely by way of example, execution of the sequences of instructions contained in the working memory 435 might cause the processor(s) 410 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 400, various computer readable media might be involved in providing instructions/code to processor(s) 410 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 425. Volatile media includes, without limitation, dynamic memory, such as the working memory 435. In some alternative embodiments, a computer readable medium may take the form of transmission media, which includes, without limitation, coaxial cables, copper wire and fiber optics, including the wires that comprise the bus 405, as well as the various components of the communication subsystem 430 (and/or the media by which the communications subsystem 430 provides communication with other devices). In an alternative set of embodiments, transmission media can also take the form of waves (including, without limitation, radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals, and/or the like, are all examples of carrier waves on which instructions can be encoded, in accordance with various embodiments of the invention.

The communications subsystem 430 (and/or components thereof) generally receives the signals, and the bus 405 then might carry the signals (and/or the data, instructions, etc. carried by the signals) to the working memory 435, from which the processor(s) 410 retrieves and executes the instructions. The instructions received by the working memory 435 may optionally be stored on a storage device 425 either before or after execution by the processor(s) 410.

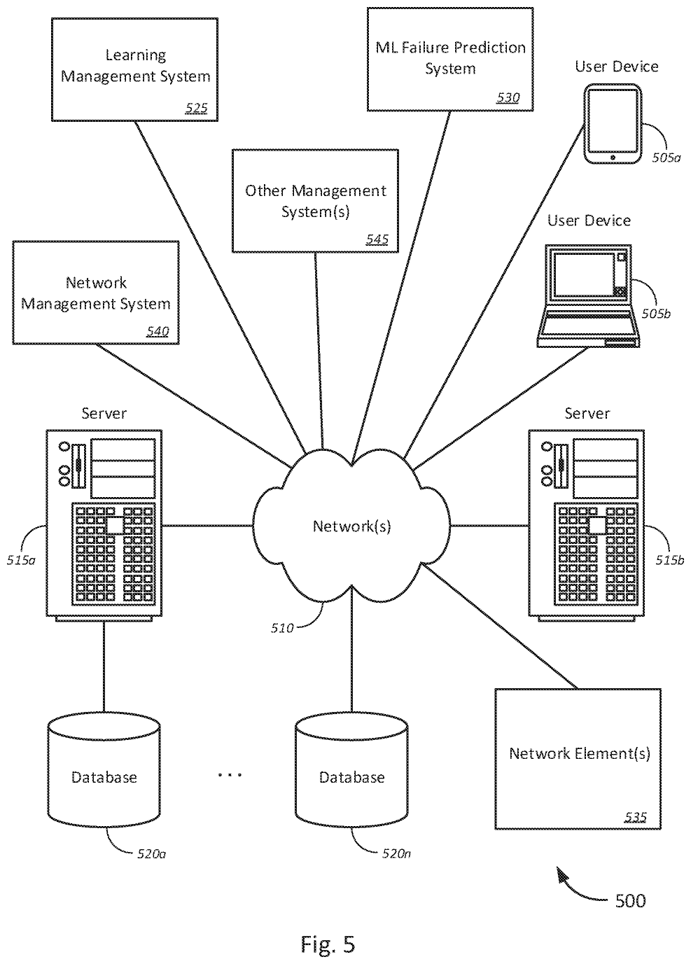

FIG. 5 is a block diagram illustrating a networked system 500, which may be used in accordance with various embodiments. The system 500 may include one or more user devices 505. A user device 505 may include, merely by way of example, desktop computers, single-board computers, tablet computers, laptop computers, handheld computers, and the like, running an appropriate operating system, which in various embodiments may include various network elements. User devices 505 may further include external devices, remote devices, servers, and/or workstation computers running any of a variety of operating systems. In some embodiments, the operating systems may include commercially-available UNIX™ or UNIX-like operating systems. A user device 505 may also have any of a variety of applications, including one or more applications configured to perform methods provided by various embodiments, as well as one or more office applications, database client and/or server applications, and/or web browser applications. Alternatively, a user device 505 may include any other electronic device, such as a thin-client computer, Internet-enabled mobile telephone, and/or personal digital assistant, capable of communicating via a network (e.g., the network(s) 510 described below) and/or of displaying and navigating web pages or other types of electronic documents. Although the exemplary system 500 is shown with two user devices 505, any number of user devices 505 may be supported.

Certain embodiments operate in a networked environment, which can include a network(s) 510. The network(s) 510 can be any type of network familiar to those skilled in the art that can support data communications using any of a variety of commercially-available (and/or free or proprietary) protocols, including, without limitation, MQTT, CoAP, AMQP, STOMP, DDS, SCADA, XMPP, custom middleware agents, Modbus, BACnet, NCTIP 1213, Bluetooth, Zigbee/Z-wave, TCP/IP, SNA™ IPX™, AppleTalk™, and the like. Merely by way of example, the network(s) 810 can each include a local area network (“LAN”), including, without limitation, a fiber network, an Ethernet network, a Token-Ring™ network and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, management network, and/or the Internet.

Embodiments can also include one or more server computers 515. Each of the server computers 515 may be configured with an operating system, including, without limitation, any of those discussed above, as well as any commercially (or freely) available server operating systems. Each of the servers 515 may also be running one or more applications, which can be configured to provide services to one or more clients 505 and/or other servers 515.

Merely by way of example, one of the servers 515 might be a data server, a web server, a cloud computing device(s), or the like, as described above. The data server might include (or be in communication with) a web server, which can be used, merely by way of example, to process requests for web pages or other electronic documents from user computers 505. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 505 to perform methods of the invention.

The server computers 515, in some embodiments, might include one or more application servers, which can be configured with one or more applications, programs, web-based services, or other network resources accessible by a client. Merely by way of example, the server(s) 515 can be one or more general purpose computers capable of executing programs or scripts in response to the user computers 505 and/or other servers 515, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 505 and/or another server 515. In some embodiments, an application server can perform one or more of the processes for implementing media content streaming or playback, and, more particularly, to methods, systems, and apparatuses for implementing video tuning and wireless video communication using a single device in which these functionalities are integrated, as described in detail above. Data provided by an application server may be formatted as one or more web pages (comprising HTML, JavaScript, etc., for example) and/or may be forwarded to a user computer 505 via a web server (as described above, for example). Similarly, a web server might receive web page requests and/or input data from a user computer 505 and/or forward the web page requests and/or input data to an application server. In some cases, a web server may be integrated with an application server.

In accordance with further embodiments, one or more servers 515 can function as a file server and/or can include one or more of the files (e.g., application code, data files, etc.) necessary to implement various disclosed methods, incorporated by an application running on a user computer 505 and/or another server 515. Alternatively, as those skilled in the art will appreciate, a file server can include all necessary files, allowing such an application to be invoked remotely by a user computer, user device, or customer device 505 and/or server 515.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520a-520n (collectively, “databases 520”). The location of each of the databases 520 is discretionary: merely by way of example, a database 520a might reside on a storage medium local to (and/or resident in) a server 515a (or alternatively, user device 505). Alternatively, a database 520n can be remote from any or all of the computers so long as it can be in communication (e.g., via the network 510) with one or more of the computers. In a particular set of embodiments, a database 520 can reside in a storage-area network (“SAN”) familiar to those skilled in the art (Likewise, any necessary files for performing the functions attributed to the computers can be stored locally on the respective computer and/or remotely, as appropriate.) In one set of embodiments, the database 520 may be a relational database configured to host one or more data lakes collected from various data sources, such as user devices 505, one or more network elements 535, or other sources. Relational databases may include, for example, an Oracle database, that is adapted to store, update, and retrieve data in response to SQL-formatted commands. The database might be controlled and/or maintained by a database server.

The system 500 may further include a learning management system 525, ML failure prediction system 530, one or more network elements 535, network management system 540, and one or more other management systems 545. Each of the learning management system 525, ML failure prediction system 530, one or more network elements 535, network management system 540, and one or more other management systems 545 may be coupled to the network 510. In some embodiments, the leaning management system 525 may be configured to determine whether one or more network elements 535, and to interface with the network management system 540, and one or more other management systems 545 to perform actions responsive to a determination that one or more network elements 535 are predicted to fail.

In various embodiments, the learning management system 525 may be configured to communicate with the ML failure prediction system 530, via the network 510. The ML failure prediction system 530 may be configured to receive, via the network 510, various KPI, telemetry information, and performance metrics from the one or more network elements. The ML failure prediction system 530 may then be configured to determine, based on the KPI, telemetry information, and performance metrics, whether one or more network elements 535 are predicted to fail. The ML failure prediction system 530 may then communicate, to the learning management system 525, whether any of the network elements 535 are predicted to fail. As previously described, in some embodiments, the ML failure prediction system 530 may be configured to determine and further provide an ID associated with the one or more network elements 535 predicted to fail to the learning management system 525.

The learning management system 525 may, in various embodiments, interface with one or more other management system 545 to further determine a location associated with the one or more network elements 535 predicted to fail. The learning management system 525 may further be configured to determine a priority for each predicted failure. In some examples, the learning management system 525 may interface with the other management system 545 to determine, for example, any SLAs associated with the one or more network elements 535 predicted to fail, and determine a priority based on the SLA. In further embodiments, other factors may be utilized to determine a priority, including, without limitation, other QoS requirements, the identity of a customer, resource availability, time and geographic restrictions and/or requirements, equipment backup or replacement (e.g., redundancy) requirements and availability, requirements on storage and/or compute resources, network resource requirements, among other factors.

Based on the priority, the learning management system 525 may determine whether replacement equipment, spares, or backups exist for a given network element of the one or more network elements 535 predicted to fail. If a spare is determined to exist, the learning management system 525 may further cause the network management system and/or one or more other management systems 545 to provision the spare equipment for use instead of the network element predicted to fail. If a spare is determined not to exist, the learning management system 525 may further leverage one or more other management systems 545 to order appropriate spare equipment and/or create work orders for the installation of the new spare equipment. In this way, the learning management system 525 may act as a self-healing system for the one or more network elements 535, by leveraging the various management systems (e.g., network management system 540 and one or more other management systems 545) to perform repairs and/or replacements of network elements predicted to fail by the ML failure prediction system. The learning management system 525 may, in some embodiments, update a priority of the predicted failure and proceed to performing one or more actions for another predicted failure in order of priority.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to certain structural and/or functional components for ease of description, methods provided by various embodiments are not limited to any single structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in sequentially for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a specific structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to one embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A system comprising:
one or more network elements;
a failure prediction system coupled to the one or more network elements, the failure prediction system configured to receive a respective data stream of one or more key performance indicators for each of the one or more network elements respectively, and to determine, based on at least one of the one or more key performance indicators, whether a network element of the one or more network elements is predicted to fail;
a learning management system coupled to the failure prediction system, the learning management system comprising:
a processor; and
non-transitory computer readable media comprising instructions executable by the processor to:
receive, via the failure prediction system, a failure prediction indicating that the network element is predicted to fail;
receive, via the failure prediction system, an identifier of physical equipment comprising the network element;
determine a location of the physical equipment comprising the network element, based on the identifier;
determine whether replacement equipment for the physical equipment is available at the location; and
provision the replacement equipment to perform one or more functions previously provided via the physical equipment.

2. The system of claim 1, further comprising:
a network management system coupled to the one or more network elements and configured to provision devices for use in a network; and
a network inventory system coupled to the one or more network elements and configured to track devices in the network including the one or more network elements;
wherein the instructions are further executable by the processor to:
obtain, via the network inventory system, the location of the physical equipment comprising based on the identifier;
determine, via the network inventory system, whether replacement equipment for the physical equipment is available; and
provision, via the network management system, the replacement equipment.

3. The system of claim 1, further comprising a business intelligence system configured to store information about customers associated with the one or more network elements, wherein the learning management system further comprises instructions executable by the processor to:
determine, via the business intelligence system, an identity of a customer associated with the network element predicted to fail; and
determine, via the business intelligence system, a service level agreement in place for the customer; and
determine, based at least in part on one or more of the identity of the customer and the service level agreement, a priority for the failure prediction,
wherein the learning management system is configured to address the failure prediction in order of priority.

4. The system of claim 3, wherein the instructions are further executable by the processor to:
receive, via the failure prediction system, a second failure indicating that a second network element is predicted fail;
determine, via the business intelligence system, a second identity of a second customer associated with the second network element predicted to fail; and
determine, via the business intelligence system, a second service level agreement in place for the second customer;
determine, based at least in part on one or more of the second identity of the second customer and the second service level agreement, a second priority for the second failure prediction;
wherein provisioning of the replacement equipment occurs responsive to a determination that the failure prediction should be addressed before the second failure prediction based on the priority and second priority.

5. The system of claim 3, wherein the instructions are further executable by the processor to:
determine, via the business intelligence system, a quality of service requirement to be provided by the network element predicted to fail; and
determine, based at least in part on the quality of service requirement, a priority for the failure prediction.

6. The system of claim 3, wherein priority for the failure prediction is further based, at least in part, on an immediacy of the failure prediction, wherein the immediacy of the failure prediction is indicative of how soon the network element is predicted to fail.

7. The system of claim 3, wherein priority for the failure prediction is further based, at least in part, on a geographic location of the physical equipment.

8. The system of claim 3, wherein priority for the failure prediction is further based, at least in part, on the existence of replacement equipment.

9. The system of claim 1, further comprising:
a work order system coupled to the learning management system and configured to create work orders and order replacement equipment;
provisioning system coupled to the learning management system and configured to automate the provisioning of new equipment in the network;
wherein the instructions are further executable by the processor to:
responsive to a determination that replacement equipment is available at the location of the physical equipment, cause, via the network management system, the replacement equipment to be used instead of the network element predicted to fail;
responsive to a determination that replacement equipment is not available at the location of the physical equipment, create, via the work order system, a work order to obtain replacement equipment for the physical equipment; and
provision, via the provisioning system, the replacement equipment ordered via the work order system to be used in the network.

10. An apparatus comprising:
a processor;
non-transitory computer readable media comprising instructions executable by the processor to:
receive, via a failure prediction system, a failure prediction indicating that the network element is predicted to fail;
receive, via the failure prediction system, an identifier of physical equipment comprising the network element;
determine, via an inventory management system, a location of the physical equipment comprising the network element, based on the identifier;
determine, via the inventory management system, whether replacement equipment for the physical equipment is available at the location of the physical equipment; and
provision, via a network management system, the replacement equipment to perform one or more functions previously provided via the physical equipment.

11. The apparatus of claim 10, wherein the instructions are further executable by the processor to:
determine, via a business intelligence system, an identity of a customer associated with the network element predicted to fail; and
determine, via the business intelligence system, a service level agreement in place for the customer; and
determine, based at least in part on one or more of the identity of the customer and the service level agreement, a priority for the failure prediction,
wherein the learning management system is configured to address the failure prediction in order of priority.

12. The apparatus of claim 11, wherein the instructions are further executable by the processor to:
receive, via the failure prediction system, a second failure indicating that a second network element is predicted fail;
determine, via the business intelligence system, a second identity of a second customer associated with the second network element predicted to fail; and
determine, via the business intelligence system, a second service level agreement in place for the second customer;
determine, based at least in part on one or more of the second identity of the second customer and the second service level agreement, a second priority for the second failure prediction;
wherein provisioning of the replacement equipment occurs responsive to a determination that the failure prediction should be addressed before the second failure prediction based on the priority and second priority.

13. The apparatus of claim 11, wherein the instructions are further executable by the processor to:
determine, via the business intelligence system, a quality of service requirement to be provided by the network element predicted to fail; and
determine, based at least in part on the quality of service requirement, the priority for the failure prediction.

14. The apparatus of claim 11, wherein the instructions are further executable by the processor to:
determine, via the failure prediction system, an immediacy of the failure prediction, wherein the immediacy of the failure prediction is indicative of how soon the network element is predicted to fail; and
determine, based at least in part on the immediacy of the failure prediction, the priority for the failure prediction.

15. The apparatus of claim 11, wherein the instructions are further executable by the processor to:
determine, via the failure prediction system, a geographic location of the physical equipment; and
determine, based at least in part on the geographic location, the priority for the failure prediction.

16. The apparatus of claim 11, wherein the instructions are further executable by the processor to:
determine, via the business intelligence system, a quality of service requirement to be provided by the network element predicted to fail; and
determine, based at least in part on the quality of service requirement, a priority for the failure prediction.

17. The apparatus of claim 11, wherein the instructions are further executable by the processor to:
responsive to a determination that replacement equipment is available at the location of the physical equipment, cause, via the network management system, the replacement equipment to be used instead of the network element predicted to fail;
responsive to a determination that replacement equipment is not available at the location of the physical equipment, create, via a work order system, a work order to obtain replacement equipment for the physical equipment; and
provision, via a provisioning system, the replacement equipment ordered via the work order system to be used in the network.

18. A method comprising:
receiving, via a failure prediction system, a failure prediction indicating that the network element is predicted to fail;
receiving, via the failure prediction system, an identifier of physical equipment comprising the network element;
determining, via an inventory management system, a location of the physical equipment comprising the network element, based on the identifier;
determining, via the inventory management system, whether replacement equipment for the physical equipment is available at the location; and
provisioning, via a network management system, the replacement equipment to perform one or more functions previously provided via the physical equipment.

19. The method of claim 18 further comprising:
determining, via a business intelligence system, an identity of a customer associated with the network element predicted to fail; and
determining, via the business intelligence system, a service level agreement in place for the customer; and
determining, based at least in part on one or more of the identity of the customer and the service level agreement, a priority for the failure prediction,
wherein the learning management system is configured to address the failure prediction in order of priority.

20. The method of claim 18 further comprising:
responsive to a determination that replacement equipment is available at the location of the physical equipment, causing, via the network management system, the replacement equipment to be used instead of the network element predicted to fail;
responsive to a determination that replacement equipment is not available at the location of the physical equipment, creating, via a work order system, a work order to obtain replacement equipment for the physical equipment; and
provisioning, via a provisioning system, the replacement equipment ordered via the work order system to be used in the network.
